(19) United States
(12) Patent Application Publication
(10) Pub. No.: US 2024/0426478 A1
(43) Pub. Date: Dec. 26, 2024

(54) CONDENSING HEAT EXCHANGER AND GAS DEVICE

(71) Applicants: WUHU MIDEA KITCHEN AND BATH APPLIANCES MFG. CO., LTD., Wuhu (CN); MIDEA GROUP CO., LTD., Foshan (CN)

(72) Inventor: Yipeng WU, Wuhu (CN)

(21) Appl. No.: 18/753,398

(22) Filed: Jun. 25, 2024

(30) Foreign Application Priority Data
Jun. 26, 2023 (CN) 202321653102.4

(51) Int. Cl. F23J 15/06; F23J 15/00

(52) U.S. Cl. CPC F23J 15/06; F23J 15/006

(57) ABSTRACT

A condensing heat exchanger includes a housing, a smoke hood and a heat exchange member. The housing is formed by integral stretching of a metal material and has an accommodation cavity with an opening at an end. The smoke hood covers on an open end of the housing to form a sealed cavity. The smoke hood is provided with a smoke outlet in communication with the sealed cavity. The housing is provided with a smoke inlet in communication with the sealed cavity. The heat exchange member is disposed in the sealed cavity.

### CROSS-REFERENCE TO RELATED APPLICATION

This application claims priority to Chinese Application No. 20231653102.4, filed on Jun. 26, 2023, the entire content of which is incorporated herein by reference.

### TECHNICAL FIELD

The disclosure relates to the technical field of hot water device, and in particular to a condensing heat exchanger and a gas device.

### BACKGROUND

At present, condensers used in gas water heaters at China and abroad include corrugated pipe-type condensers, plain-pipe type condensers, and finned tube condensers. The current way of increasing a heat exchange efficiency mainly relies on increasing a heat exchange area, that is, using a corrugated pipe, adding fins and so on. In order to prevent condensed water from corroding a sheet metal of a housing, existing condensing heat exchangers mostly use a brazing structure with good reliability, which has a relatively complex process and high cost.

### SUMMARY

A main purpose of the disclosure is to provide a condensing heat exchanger and a gas water heater, aiming to solve problems of complex process and high cost of a housing in the related art.

To achieve the above purpose, the disclosure proposes a condensing heat exchanger including: a housing, formed by integral stretching of a metal material and having an accommodation cavity with an opening at an end; a smoke hood, covered on an open end of the housing to form a sealed cavity; and the smoke hood is provided with a smoke outlet which is in communication with the sealed cavity, the housing being provided with a smoke inlet which is in communication with the sealed cavity; and a heat exchange member, disposed in the sealed cavity.

In some embodiments, the condensing heat exchanger further includes a baffle plate disposed in the accommodation cavity; a diversion flue duct is formed between the baffle plate and a bottom wall of the housing; and the heat exchange member is disposed in the diversion flue duct.

The smoke inlet is disposed at a bottom wall of the housing; a smoke passing port communicating the diversion flue duct and the smoke outlet is disposed at the baffle plate; the smoke inlet and the smoke passing port are disposed far away from each other.

In some embodiments, the housing has a first side and a second side disposed oppositely along a first direction; the first direction intersects a vertical direction.

An end of the baffle plate is connected to the first side, and another end of the baffle plate is spaced apart from the second side to form the smoke passing port; the smoke inlet is disposed close to the first side.

In some embodiments, the baffle plate has a diversion surface facing the smoke inlet; the diversion surface is an arc-shaped surface arched toward a direction away from the smoke inlet.

In some embodiments, a projection of the heat exchange member on the bottom wall of the housing is offset from the smoke inlet.

In some embodiments, the baffle plate is divided into a first plate section and a second plate section along the first direction; the first plate section is connected to the first side and faces the smoke inlet obliquely; the second plate section extends from a side of the first plate section close to the second side and is tilted downward; the bottom wall of the housing is provided with a boss which faces the second plate section and has a same inclination direction as the second plate section; and the diversion flue duct is formed between the second plate section and the boss.

In some embodiments, the second plate section and the boss are inclined downward relative to the horizontal plane at an angle not less than 5 degrees and not more than 10 degrees.

In some embodiments, a first rib is disposed at a top surface of the boss, and a second rib is disposed at a bottom surface of the second plate section; the first rib and the second rib respectively abut against two opposite sides of the heat exchange member.

In some embodiments, the heat exchange member comprises a corrugated pipe disposed in a curved shape.

In some embodiments, the housing further has a third side and a fourth side disposed opposite to each other along a second direction; the corrugated pipe is bent back and forth between the third side and the fourth side; and the first direction, the second direction and the vertical direction intersect one another.

In some embodiments, the condensing heat exchanger further includes a water inlet connector which is in communication with a water inlet end of the heat exchange member, and a water outlet connector which is in communication with a water outlet end of the heat exchange member; the housing has a slotted hole for ends of the water inlet connector and the water outlet connector to respectively penetrate for connecting and fixing.

In some embodiments, the water inlet end and the water outlet end of the heat exchange member are disposed at a same side of the heat exchange member.

The condensing heat exchanger further comprises a mounting member on which the water outlet connector and the water inlet connector are mounted; and the mounting member is connected to the housing.

In some embodiments, a first seal member is disposed between connection surfaces of the mounting member and the housing.

In some embodiments, a connection member protrudes from a periphery of the baffle plate in a vertical direction; first through holes are opened on the connection member; second through holes are opened on a side wall of the housing corresponding to various first through hole; and first fasteners pass through the second through holes and the first through holes in sequence to fix the baffle plate to the housing.

In some embodiments, the condensing heat exchanger further includes a connection flange disposed at a bottom of the housing; the connection flange is provided with a cavity body having an opening facing downwards; a top wall of the connection flange is provided with a smoke passing hole communicating the cavity body to the smoke inlet.

In some embodiments, a second seal member is disposed between connection surfaces of the smoke passing hole and the smoke inlet.

In some embodiments, a diversion slope is disposed at a top wall of the cavity body. The diversion slope is disposed to extend obliquely upward from a side of the cavity body away from the smoke passing port to a side of the cavity body close to the smoke passing port 61.

In some embodiments, a water collection groove is disposed at a position of the bottom wall of the housing close to the second side; and a drain port is disposed at a bottom wall of the water collection groove.

In some embodiments, an open end of the housing is folded outward to form a first flanging; and fixing holes for second fasteners to pass through are correspondingly disposed at the first flanging and the smoke hood.

The disclosure also provides a gas device, including any one of the above-mentioned condensing water heaters.

The housing in the technical solution of the disclosure is formed by integral stretching of metal materials such as stainless steel. The housing, compared with a housing in the related art which is formed by brazing several plates, has a simple production process and a low production cost.

### BRIEF DESCRIPTION OF DRAWINGS

In order to more clearly illustrate the technical solutions in the embodiments of the disclosure or in the related art, the accompanying drawings required for use in the description for the embodiments or the related art will be briefly introduced below. Obviously, the accompanying drawings described below are only some embodiments of the disclosure. For those skilled in the art, other accompanying drawings can be obtained based on the structures shown in these accompanying drawings without creative work.

FIG. 1 is an axonometrical view of a condensing heat exchanger according to an embodiment of the disclosure;

FIG. 2 is an exploded view of the condensing heat exchanger in FIG. 1;

FIG. 3 is a cross sectional view of a condensing heat exchanger according to an embodiment of the disclosure;

FIG. 4 is a cross sectional view of a condensing heat exchanger according to another embodiment of the disclosure;

FIG. 5 is a schematic diagram of a baffle plate of a condensing heat exchanger according to an embodiment of the disclosure;

FIG. 6 is a schematic diagram of a housing of a condensing heat exchanger according to an embodiment of the disclosure;

FIG. 7 is an axonometrical view of a corrugated pipe of the condensing heat exchanger in FIG. 3; and

FIG. 8 is an axonometrical view of a corrugated pipe of the condensing heat exchanger in FIG. 4.

### REFERENCE NUMERAL

| Numeral | Name | Numeral | Name |
|---|---|---|---|
| 100 | condensing heat | 30 | heat exchange |
| | exchanger | | member |
| 10 | housing | 40 | baffle plate |
| 101 | accommodation | 41 | first plate section |
| | cavity | | |
| 102 | smoke inlet | 42 | second plate section |
| 10a | first side | 421 | second rib |
| 10b | second side | 43 | connection member |
| 10c | third side | 50 | connector assembly |
| 10d | fourth side | 51 | water inlet connector |
| 11 | bottom wall | 52 | water outlet |
| | | | connector |
| 12 | boss | 53 | mounting member |
| 121 | first rib | 54 | first seal member |
| 104 | first flanging | 60 | connection flange |
| 103 | water collection | 61 | smoke passing hole |
| | groove | | |
| 20 | smoke hood | 62 | second seal member |
| 201 | smoke outlet | 63 | diversion slope |
| 70 | drain nozzle | 44 | diversion surface |
| 80 | diversion flue duct | 45 | smoke passing port |
| 30a | corrugated pipe | 31 | water inlet end |
| 32 | water outlet end | 105 | slotted hole |
| 1031 | drain port | | |

A realization of an object, functional characteristics and advantages of the disclosure will be further explained in conjunction with embodiments and with reference to the accompanying drawings.

### DESCRIPTION OF EMBODIMENTS

Technical solutions in embodiments of the disclosure will be described clearly and completely below in conjunction with the accompanying drawings in the embodiments of the disclosure. Obviously, the described embodiments are only some embodiments of the disclosure, rather than all embodiments. Based on the embodiments of the disclosure, all other embodiments obtained by those skilled in the art without making any creative work shall fall within the scope of protection of the disclosure.

It should be noted that if the embodiments of the disclosure involve directional indications (such as up, down, left, right, front, back . . . ), the directional indications are only used to explain a relative position relationship, a movement status and so on between members under a certain specific posture (as shown in accompanying drawings). If the specific posture changes, the directional indications will also change accordingly.

In addition, if there are descriptions involving “first”, “second” and so on in the embodiments of the disclosure, the descriptions of “first”, “second” and so on are only used for descriptive purposes and cannot be understood as indicating or implying relative importance thereof or implicitly indicating the number of the indicated technical features. Therefore, a feature associated with “first” or “second” may explicitly or implicitly include at least one of the feature. In addition, the technical solutions between various embodiments can be combined with each other, as long as the embodiments do not conflict with each other.

A condensing heat exchanger is provided according to embodiments of the disclosure.

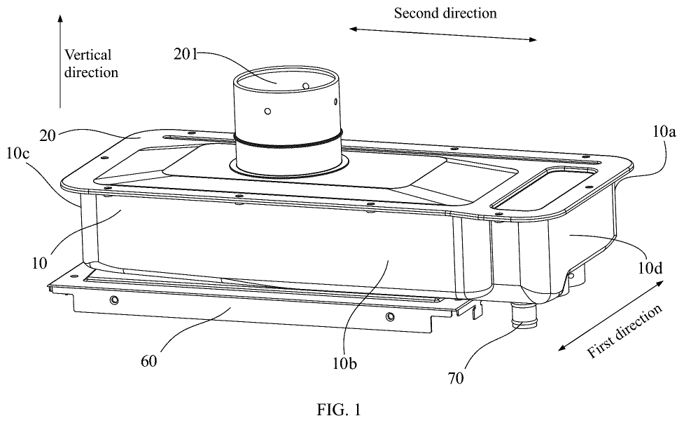

As shown in FIG. 1 to FIG. 6, the condensing heat exchanger 100 according to embodiments of the disclosure may include a housing 10, a smoke hood 20 and a heat exchange member 30. The housing 10 is formed by integral stretching of a metal material and has an accommodation cavity 101 with an opening at an end. The smoke hood 20 is covered on an end with an opening of the housing 10 to form a sealed cavity. The smoke hood 20 is provided with a smoke outlet 201 being in communication with the sealed cavity. The housing 10 is provided with a smoke inlet 102 being in communication with the sealed cavity. The heat exchange member 30 is disposed in the sealed cavity.

In some embodiments, the condensing heat exchanger 100 can be used as a secondary heat exchanger for a gas device (such as a gas water heater or a gas hot water heating furnace and so on). A gas water heater is taken as an example, and the gas water heater includes a combustion chamber for providing a place for combustion and forming a high-temperature flue gas, and a primary heat exchanger. The primary heat exchanger may be a coil heat exchanger wrapped around a peripheral wall of the combustion chamber, or a fin heat exchanger disposed at a top of the combustion chamber. The condensing heat exchanger 100 can be used as a secondary heat exchanger disposed above the combustion chamber or the primary heat exchanger. After the high-temperature flue gas generated through the combustion in the combustion chamber passes through the primary heat exchanger for a heat exchange, the flue gas enters the secondary heat exchanger (i.e., the condensing heat exchanger 100) for a secondary heat exchange, and thus a latent heat in the flue gas can be fully utilized to increase a whole efficiency of the condensing heat exchanger.

In some embodiments, the housing 10 may be made of sheet metal material. In an embodiment, the housing 10 may be formed by integral stretching of 304 stainless steel through an integrated stretching process, and thus the housing 10 as a whole has a strong structural strength and corrosion resistance. The housing 10, compared with a housing in the related art which is formed by brazing several plates, has a simple production process and a low production cost. In some embodiments, the smoke hood 20 may also be formed by integral stretching of 304 stainless steel through the integrated stretching process. The smoke hood 20 may be mounted on an open end of the housing 10 by welding, screw connection and so on, to seal the accommodation cavity 101 of the housing 10 and fit with the accommodation cavity 101 to form a sealed cavity, and thus the flue gas entering the sealed cavity from the smoke inlet 102 is, after being subject to the heat exchange through the heat exchange member 30, discharged from the smoke outlet 201 of the smoke hood 20. Thus a heat exchange effect is improved.

In some embodiments, the heat exchange member 30 is provided as a curved corrugated pipe 30a, and the corrugated pipe 30a may be made of 304 or 316 stainless steel. The corrugated pipe 30a, compared with other stainless steel tubes with a bending arrangement, has high flexibility. When a volume of a diversion flue duct is constant, the corrugated pipe 30a with a larger length can be accommodated therein, and thus a better heat exchange effect can be achieved. It can be understood that the heat exchange member 30 is disposed in a curved shape, to form a tortuous flow channel inside the heat exchange member 30 for a flow of fluid (such as water). This allows a length and heat exchange area of the heat exchange member 30 to be increased as much as possible within a limited space, and thus a heat exchange efficiency between the flue gas in the diversion flue duct and a fluid in the heat exchange member 30 can be improved and a miniaturization can be facilitated. The flue gas, when passing through the heat exchange member 30, can exchange heat with a fluid in the heat exchange member 30, and thus a temperature of the fluid increases and a temperature of the flue gas decreases. It should be noted that, in other embodiments, the heat exchange member 30 may also be a U-shaped pipe, a serpentine pipe, a spiral pipe and so on.

In some technical solutions of the disclosure, the heat exchange member 30 in the housing 10 of the condensing heat exchanger 100 is disposed in a curved shape, and thus a length and a heat exchange area of the heat exchange member 30 can be increased as much as possible within a limited space, to improve the heat exchange efficiency between the flue gas entering the sealed cavity from the smoke inlet 102 and the fluid in the heat exchange member 30 and to facilitate an implementation of a miniaturization. The heat exchange effect is ensured, and at the same time an overall height of the housing 10 can be designed to be lower, and thus the housing 10 can be formed by integral stretching of metal materials such as stainless steel. The housing 10, compared with a housing in the related art which is formed by brazing several plates to enclose an accommodation cavity, has a simple production process and a low production cost.

In an embodiment, the condensing heat exchanger 100 further includes a baffle plate 40, which is disposed in the accommodation cavity 101. A diversion flue duct is formed between the baffle plate 40 and a bottom wall 11 of the housing 10, and the heat exchange member 30 is disposed in the diversion flue duct. The smoke inlet 102 is disposed at the bottom wall 11 of the housing 10. A smoke passing port 45 communicating the diversion flue duct and the smoke outlet 201 is disposed at the baffle plate 40. The smoke inlet 102 and the smoke passing port 45 are disposed far away from each other. With such arrangement, a distance between the smoke passing port 45 and the smoke inlet 102 is relatively larger to cause the flue gas to stay in the diversion flue duct for a relatively long time, and thus a better condensation effect can be achieved. In some embodiments, the baffle plate 40 may be disposed to completely cover an open end of the accommodation cavity 101, and a notch or a hole is opened at a position of the baffle plate 40 away from the smoke inlet 102 as the smoke passing port 45, to cause all the flue gas entering into the diversion flue duct to be discharged from the smoke outlet 201 after passing through the smoke passing port 45. In other embodiments, a length of an end of the baffle plate 40 away from the smoke inlet 102 may be reduced, to form a gap between an end of the baffle plate 40 away from the smoke inlet 102 and a side wall of the housing 10 facing the end of the baffle plate 40 away from the smoke inlet 102, as a smoke passing port 45 for the flue gas in the diversion flue duct to be discharged, which is not limited here.

In an embodiment, the housing 10 has a first side 10a and a second side 10b disposed oppositely along a first direction. The first direction may be a length direction or a width direction of the housing 10, as long as the first direction intersects a vertical direction. “The first direction intersects a vertical direction” may be understood as that the first direction and the vertical direction are perpendicular to each other or have a certain inclination angle relative to each other. In some embodiments, the first direction is the width direction of the housing 10 (a front-to-rear direction as shown in FIG. 1). The condensing heat exchanger 100 also includes a baffle plate 40, which is disposed at a side with the opening of the accommodation cavity 101. An end of the baffle plate 40 is connected to the first side 10a, and another end of the baffle plate 40 is spaced apart from the second side 10b. A diversion flue duct is formed between the baffle plate 40 and the bottom wall 11 of the housing 10. The smoke inlet 102 is disposed at a position of the bottom wall 11 of the housing 10 close to the first side 10a. An end of the diversion flue duct close to the second side 10b is in communication with the smoke outlet 201. The heat exchange member 30 is disposed in the diversion flue duct.

In some embodiments, the baffle plate 40 may be made of sheet metal material through an integrated stretching process to avoid splicing and welding. The baffle plate 40 may be mounted in the housing 10 through connecting manners of screwing or welding and so on. In other embodiments, the baffle plate 40 may be tilted downward at a certain angle relative to a horizontal plane. A portion of the bottom wall 11 of the housing 10 facing an inclined plate section of the baffle plate 40 also has a slope with a certain inclination, to form the diversion flue duct extending inclinedly downward between the baffle plate 40 and the bottom wall 11 of the housing 10. The baffle plate 40 is spaced apart from an inner wall surface of the second side 10b of the housing 10 to form the diversion flue duct for a flowing of the flue gas. The flue gas flows upward from the smoke inlet 102 disposed close to the first side 10a on the bottom wall 11 of the housing 10 into the sealed cavity. The flue gas can flow, under a diversion effect of the baffle plate 40, along the diversion flue duct from the first side 10a of the housing 10 toward the second side 10b. The flue gas, when flowing to a position close to the second side 10b, can flow upward and finally be discharged from the smoke outlet 201 at a top of the housing 10. In this way, a flow path of the flue gas from the smoke inlet 102 to the smoke outlet 201 is a nonlinear tortuous path, which is advantageous to increase a residence time of the flue gas in the housing 10, and thus the flue gas and the heat exchange member 30 are fully in contact for the heat exchange, and the heat exchange efficiency is improved.

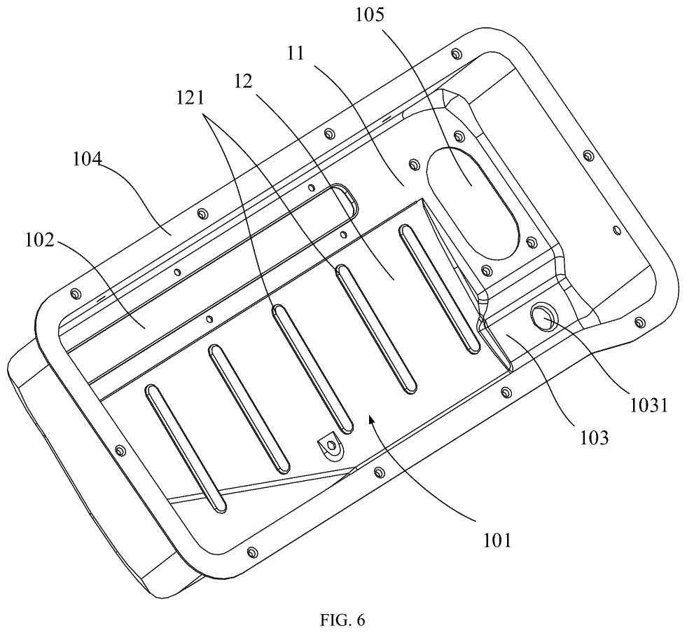

As shown in FIG. 6, in some embodiments, a water collection groove 103 is disposed at a position of the bottom wall 11 of the housing 10 close to the second side 10b, and a drain port 1031 is disposed at a bottom wall of the water collection groove 103. A condensed water generated after the heat exchange drips onto an inclined bottom surface of the diversion flue duct and can flow along an inclined slope to a position close to the second side 10b, and finally the condensed water collected in the water collection groove 103 is discharged from the drain port 1031. In some embodiments, a drain nozzle 70 is disposed at the drain port 1031. The housing 10 can be conveniently connected to a condensation collection box through the drain nozzle 70, and thus the condensed water discharged from the drain port 1031 can flow into the condensation collection box via the drain nozzle 70.

In an embodiment, the baffle plate 40 has a diversion surface 44 facing the smoke inlet 102. The diversion surface 44 is an arc-shaped surface arched toward a direction away from the smoke inlet 102.

In some embodiments, an arc-shaped diversion surface 44 is disposed at a side of the baffle plate 40 facing the smoke inlet 102. On the one hand, a flow direction of the flue gas can be smoothly changed to change the flue gas from flowing vertically to flowing horizontally; on the other hand, the flue gas flowing upward from the smoke inlet 102 can flow along a surface of the heat exchange member 30 under a guidance of the arc-shaped diversion surface 44, to bring the flue gas into full contact with the surface of the heat exchange member 30, and thus the heat exchange efficiency is further improved. In some embodiments, a curvature of the arc-shaped surface of the diversion surface 44 is not less than 35 degrees and not more than 45 degrees. In further embodiments, the curvature of the arc-shaped surface of the diversion surface 44 can be designed to be 35°, 40°, 45° and so on.

In an embodiment, a projection of the heat exchange member 30 on the bottom wall 11 of the housing 10 is offset from the smoke inlet 102.

It is understandable that when the flue gas passes through the diversion flue duct, the flue gas will exchange heat with the fluid in the heat exchange member 30. At this time, a condensed water will condense on an outer surface of the heat exchange member 30. If the heat exchange member 30 is arranged directly above the smoke inlet 102, the condensed water condensed on the outer surface of the heat exchange member 30 may drip from the heat exchange member 30 and directly drip into the smoke inlet 102 during the heat exchange. Therefore, in this embodiment, the projection of the heat exchange member 30 on the bottom wall 11 of the housing 10 is offset from the smoke inlet 102, that is, the heat exchange member 30 is not placed directly above the smoke inlet 102, and thus the condensed water can be prevented from dripping into the smoke inlet 102 to ensure a reliability of the condensing heat exchanger 100.

In an embodiment, the baffle plate 40 is divided into a first plate section 41 and a second plate section 42 along a first direction. The first plate section 41 is connected to the first side 10a and faces the smoke inlet 102 obliquely. In another embodiment, the first plate section 41 is disposed in a form of an arc-shaped plate that is arched away from the smoke inlet 102. The second plate section 42 extends from a side of the first plate section 41 close to the second side 10b and is tilted downward. The bottom wall 11 of the housing 10 is provided with a boss 12 which faces the second plate section 42 and has a same inclination direction as the second plate section 42. The diversion flue duct is formed between the second plate section 42 and the boss 12.

In some embodiments, the first plate section 41 is disposed as an arc-shaped plate, to form an arc-shaped diversion surface 44 on a side of the first plate section 41 facing the smoke inlet 102. The flue gas flowing upward from the smoke inlet 102 can flow obliquely downward along an extension direction of the second plate section 42 under a guidance of the first plate section 41. In this way, a flow direction of the flue gas can be smoothly changed, and the flue gas can flow along a surface of the heat exchange member 30 under a guidance of the arc-shaped diversion surface 44, to bring the flue gas into full contact with the surface of the heat exchange member 30, and thus the heat exchange efficiency is further improved. The bottom wall 11 of the housing 10 is provided with a boss 12 facing the second plate section 42. The boss 12 and the second plate section 42 have a same inclination direction and substantially a same inclination angle, to form the diversion flue duct extending obliquely downward between the second plate section 42 and the boss 12. During the heat exchange, the condensed water on the surface of the heat exchange member 30 drips onto the boss 12 and can flow downward along a slope of the boss 12 to a position close to the second side 10b. In some embodiments, a water collection groove 103 is disposed at a position of the bottom wall 11 of the housing 10 close to the second side 10b, and a drain port 1031 is disposed at a bottom wall of the water collection groove 103. A drain nozzle 70 is disposed at the drain port 1031. The housing 10 can be conveniently connected to a condensation collection box through the drain nozzle 70, and thus the condensed water discharged from the drain port 1031 can flow into the condensation collection box via the drain nozzle 70.

In practical applications, the baffle plate 40 may be made of a sheet metal. The first plate section 41 and the second plate section 42 may be bent and formed by integral stretching of the sheet metal. In this way, a forming process is simple and a manufacture is convenient. The housing 10 may be made of sheet metal. The boss 12 upwardly protruding can be directly formed on the bottom wall 11 of the housing 10 by stamping. A position where the boss 12 is disposed at the bottom wall 11 of the housing 10 is bent upward to form a slope with a certain inclination, and thus the boss 12 also has a slope with a certain inclination. Thus a forming process is simple and a manufacture is convenient.

In an embodiment, the second plate section 42 and the boss 12 are inclined downward relative to the horizontal plane at an angle not less than 5 degrees and not more than 10 degrees. In some embodiments, the angle may be 5 degrees, 6 degrees, 7 degrees, 8 degrees, 9 degrees, 10 degrees or any value therebetween. In another embodiment, the second plate section 42 and the boss 12 are inclined downward at an angle of 6 degrees relative to the horizontal plane. The inventors have verified through repeated experiments that when the diversion flue duct is inclined downward by about 6 degrees, a diversion effect for the flue gas is better.

In an embodiment, a first rib 121 is disposed at a top surface of the boss 12, and a second rib 421 is disposed at a bottom surface of the second plate section 42. The first rib 121 and the second rib 421 respectively abut against two opposite sides of the heat exchange member 30.

It is understandable that the flue gas, when flowing in the diversion flue duct, will generate a certain impact force on the heat exchange member 30, to cause the heat exchange member 30 to shake. In order to ensure a stability of the heat exchange member 30, in an embodiment, the heat exchange member 30 is clamped by the first rib 121 and the second rib 421, and thus the heat exchange member 30 can be prevented from shaking when the flue gas passes through and the stability of a mounting of the heat exchange member 30 can be ensured. In some embodiments, the first rib 121 and the second rib 421 can also function as reinforcing ribs, which are advantageous for enhancing structural strengths of the housing 10 and the baffle plate 40 and preventing deformation.

In some embodiments, at least two first ribs 121 are disposed at an interval on the top surface of the boss 12 and at least two second ribs 421 are disposed at an interval on the bottom surface of the second plate section 42, to increase a contact area with the heat exchange member 30. In some embodiments, the first ribs 121 and the second ribs 421 are both strip-shaped ribs extending along the first direction. Extending directions of the first ribs 121 and the second ribs 421 are consistent with a flow direction of the flue gas in the diversion flue duct, and thus a resistance of flowing of the flue gas can be reduced. At the same time, a certain gaps are provided between contact surfaces of the boss 12 and the heat exchange member 30, and between contact surfaces of the second plate section 42 and the heat exchange member 30, and thus an upper surface and a lower surface of the heat exchange member 30 can also participate in the heat exchange to further improve the heat exchange efficiency.

In an embodiment, the housing 10 further has a third side 10c and a fourth side 10d disposed opposite to each other along the second direction. The corrugated pipe 30a is bent back and forth between the third side 10c and the fourth side 10d. The first direction, the second direction and the vertical direction intersect one another.

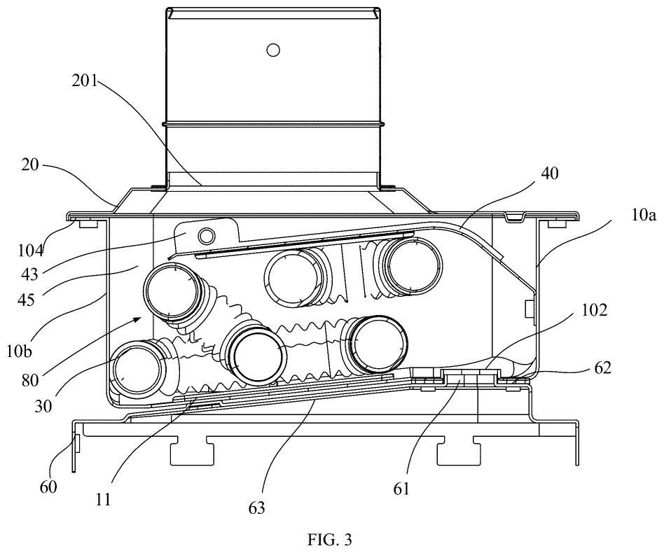

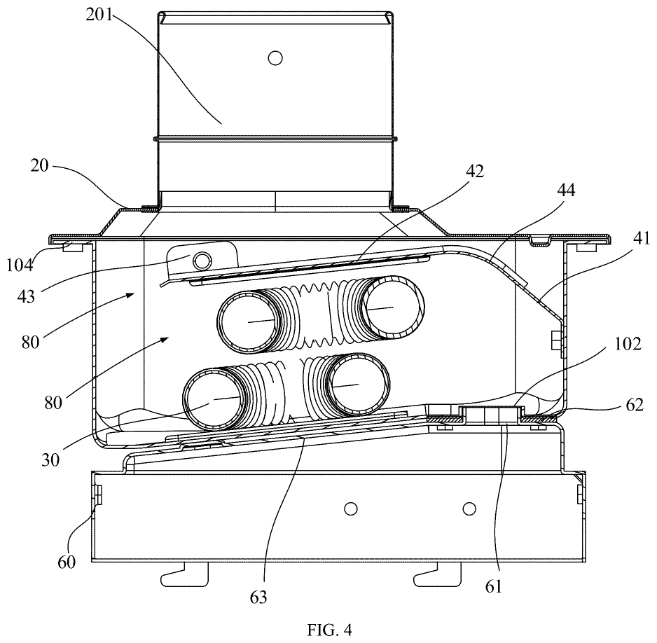

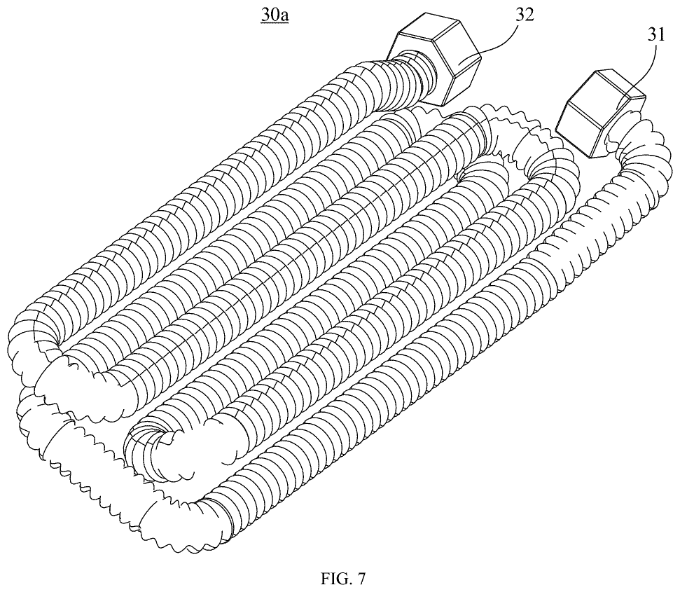

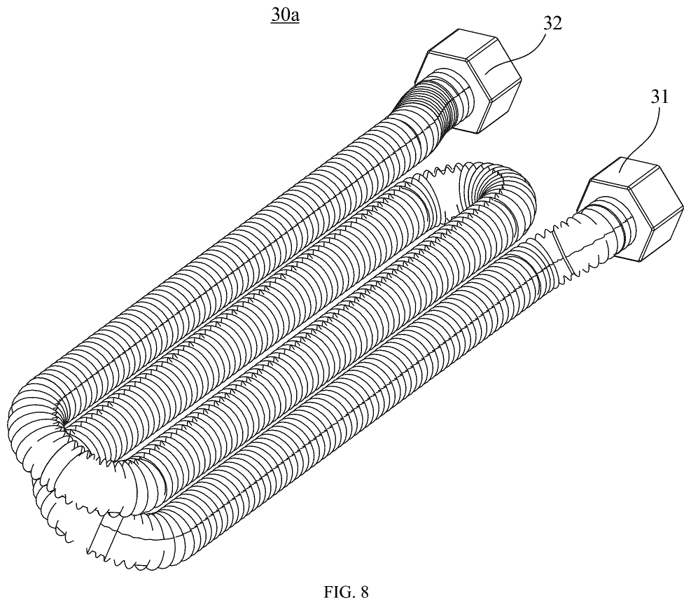

In some embodiments, one of the first direction and the second direction is a width direction of the housing 10, and the other one of the first direction and the second direction is a length direction of the housing 10. In an embodiment, the first direction may be the width direction of the housing 10 (that is, a front-to-rear direction shown in FIG. 1), and the second direction may be the length direction of the housing 10 (that is, a left-to-right direction shown in FIG. 1). The heat exchange member 30 may be a serpentine pipe that bends back and forth between the third side 10c and the fourth side 10d, and thus a length and a heat exchange area of the heat exchange member 30 can be increased within a limited space to improve the heat exchange efficiency. The number of bending times of the heat exchange member 30 may be set according to actual needs. In some embodiments, it can be seen from FIG. 3 which is a cross-sectional view taken along the first direction, or from FIG. 7 which is an axonometrical view that the heat exchange member 30 is in a cross arrangement. In an embodiment, the heat exchange member 30 exhibits an upper and lower double-layer winding structure by performing six 180° bends, and the longitudinal cross-section of the heat exchange member 30 is shown in the FIG. 3. A cross-section of each of straight pipe sections of the heat exchange member 30 extending along the second direction is staggered along the first direction. In yet another embodiment, as shown in FIG. 4 and FIG. 8, the heat exchange member 30 generally exhibits an “M”-shaped structure by performing three 180 degrees folding. Of course, in practical application, the above structure is not limited to be used here.

In order to make the best use of a space in the diversion flue duct to enable the flue gas to fully contact and exchange heat with the heat exchange member 30. In other embodiments, as shown in FIGS. 3 and 7, the heat exchange member 30 includes a first heat exchange section and a second heat exchange section stacked vertically, and the first heat exchange section and the second heat exchange section are staggered in the first direction.

In an embodiment, the heat exchange member 30 may include two corrugated pipes which are a first heat exchange section and a second heat exchange section respectively. The first heat exchange section and the second heat exchange section each include several straight pipe sections and bent pipe sections. Every two adjacent straight pipe sections of the first heat exchange section and every two adjacent straight pipe sections of the second heat exchange section are connected by one bent pipe section respectively. Each straight pipe section extends along the second direction (for example, left-to-right direction). The straight pipe sections of the first heat exchange section and the straight pipe sections of the second heat exchange section are staggered with one other in the first direction (for example, the front-to-rear direction), that is, a straight pipe section of one corrugated pipe corresponds to a gap between two adjacent rows of straight pipe sections of another corrugated pipe. In this way, as many rows of heat exchange members 30 as possible can be stacked without changing a vertical size of the diversion flue duct, and an area of the straight pipe section of the one corrugated pipe sheltered by the two adjacent rows of the straight pipe sections of the another corrugated pipe is small, which is conducive to a sufficient contact and the heat exchange between the heat exchange members 30 and the flue gas, and thus the heat exchange efficiency can be improved and an overall volume can be miniaturized.

In an embodiment, the condensing heat exchanger 100 also includes a water inlet connector 51 being in communication with a water inlet end 31 of the heat exchange member 30, and a water outlet connector 52 being in communication with a water outlet end 32 of the heat exchange member 30. The housing 10 has a slotted hole 105 for ends of the water inlet connector 51 and the water outlet connector 52 to respectively penetrate for connecting and fixing.

In some embodiments, the water inlet connector 51 and the water outlet connector 52 can be pre-mounted and pre-fixed on the housing 10 by disposing the slotted hole 105, and then the water inlet end 31 of the heat exchange member 30 is connected to the water inlet connector 51 through a locking nut, to enable the water inlet end 31 of the heat exchange member 30 to be in communication with a water inlet channel inside the water inlet connector 51. Correspondingly, the water outlet end 32 of the heat exchange member 30 is connected to the water outlet connector 52 through a locking nut, and thus a mounting of the heat exchange member 30 is simpler and more convenient. An external delivery pipeline for medium only needs to be connected to the water inlet connector 51 and the water outlet connector 52 mounted on the housing 10, and thus an assembly of the condensing heat exchanger 100 is simpler.

In an embodiment, the water inlet end 31 and the water outlet end 32 of the heat exchange member 30 are disposed at a same side of the heat exchange member 30. The condensing heat exchanger 100 also includes a mounting member 53. The water outlet connector 52 and the water inlet connector 51 are mounted on the mounting member 53, and the mounting member 53 is connected to the housing 10.

In an embodiment, in order to reduce a difficulty of wiring pipeline inside a gas device using the condensing heat exchanger 100, the water inlet end 31 and the water outlet end 32 of the heat exchange member 30 are disposed at the same side of the heat exchange member 30. In some embodiments, the water inlet end 31 and the water outlet end 32 of the heat exchange member 30 may be placed on the third side 10c or the fourth side 10d of the housing 10, which is not limited here. In some embodiments, since the water inlet end 31 and the water outlet end 32 of the heat exchange member 30 are both placed on the same side of the heat exchange member 30, in this way, in order to facilitate a mounting of the water inlet connector 51 and the water outlet connector 52, the mounting member 53 is further disposed in this embodiment. The mounting member 53 in this embodiment is a mounting plate. The water inlet connector 51 and the water outlet connector 52 are integrated side by side in the mounting plate. In this way, when the water inlet connector 51 and the water outlet connector 52 needs to be mounted, it is only required to fix the mounting plate to complete a mounting of the water inlet connector 51 and the water outlet connector 52. The water inlet connector 51, the water outlet connector 52 and the mounting plate can be processed integrally during production and processing, and thus the number of parts of the condensing heat exchanger 100 can be reduced.

In an embodiment, a first seal member 54 is disposed between connection surfaces of the mounting member 53 and the housing 10.

In some embodiments, the first seal member 54 is configured as a sealing gasket, and the first seal member 54 has an avoidance hole for the water outlet connector 52 and the water inlet connector 51 to pass therethrough. In some embodiments, the mounting of the mounting member 53 on the bottom wall 11 of the housing 10 is taken as an example. The mounting member 53, the first seal member 54 and the bottom wall 11 of the housing 10 are provided with through holes for screws to pass through. The screws pass through the mounting member 53, the first seal member 54 and the through holes reserved on the bottom wall 11 of the housing 10 in turn, to fix the mounting member 53 on the housing 10. At the same time, due to a presence of the first seal member 54, the flue gas or condensed water in the housing 10 can be prevented from seeping out from a connection gap between the mounting member 53 and the housing 10.

In an embodiment, a connection member 43 protrudes from a periphery of the baffle plate 40 in the vertical direction. First through holes are opened on the connection member 43. Second through holes are opened on a side wall of the housing 10 corresponding to various first through holes. First fasteners pass through the second through holes and the first through holes in sequence to fix the baffle plate 40 to the housing 10.

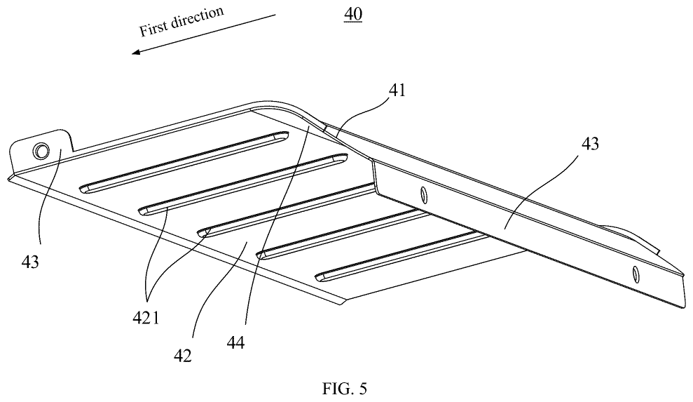

In some embodiments, as shown in FIG. 5, an end of the baffle plate 40 connected to the first side 10a of the housing 10 is bent vertically downward to form a flanging, which is the connection member 43. The first through holes are disposed at the flange. Correspondingly, second through holes are opened on the housing 10 that are disposed ate-to-one with each first through hole. In this way, the baffle plate 40 can be fixed to the housing 10 by screws passing through the first through holes and the second through holes one by one, which reduces a process difficulty and has a relatively low cost compared to fixing the baffle plate 40 to the housing 10 by brazing. In other embodiments, the connection member 43 may also be disposed at two opposite sides of the baffle plate 40 along the second direction, to respectively protrude upward along a setting direction to be formed as lugs. The first through holes are opened on the lugs. The second through holes are opened on the third side 10c of the housing 10 corresponding to various first through holes. The first fastener may be a fastener such as a screw or a bolt. The first fastener selected as a screw is taken as an example for illustrating in this embodiment. Each screw passes through corresponding first through hole and the second through hole in turn for locking and fixing, and thus two sides of the baffle plate 40 along the second direction are also fixed to the housing 10 by screws respectively to ensure a reliability of mounting for the baffle plate 40 and the housing 10 and reduce a cost of mounting.

In an embodiment, in order to facilitate a mounting of the condensing heat exchanger 100, as shown in FIG. 3 and FIG. 6, the smoke inlet 102 is disposed at the bottom wall 11 of the housing 10, and the condensing heat exchanger 100 further includes a connection flange 60 disposed at a bottom of the housing 10. The connection flange 60 is provided with a cavity body having an opening facing downwards. A top wall of the connection flange 60 is provided with a smoke passing hole 61 communicating the cavity body to the smoke inlet 102.

In some embodiments, the connection flange 60 is assembled to the bottom of the housing 10 by, but not limited to, welding, riveting, fastener connection and so on. In actual use, the connection flange 60 may be covered on the combustion chamber of the gas device or a top of the primary heat exchanger to form a sealed connection. In some embodiments, when the primary heat exchanger is a coil heat exchanger wrapped around a periphery of the combustion chamber, the condensing heat exchanger 100 can be directly mounted on a top of the combustion chamber through the connection flange 60. When the primary heat exchanger is disposed at the top of the combustion chamber, the condensing heat exchanger 100 can be mounted on the top of the primary heat exchanger through the connection flange 60. The flue gas after being subject to a primary heat exchange flows upward to the cavity body of the connection flange 60, in which the flue gas is collected, and then enters into the housing 10 via the smoke passing hole 61 and the smoke inlet 102. A shape of the smoke passing hole 61 matches that of the smoke inlet 102. The smoke passing hole 61 and the smoke inlet 102 includes but not limited to a circular opening, a square opening or other irregularly-shaped openings. In order to increase a flow area of the flue gas as much as possible, in some embodiments, the smoke inlet 102 and the smoke passing hole 61 are both configured as an oblong hole extending from a side to another side of the housing 10. In some embodiments, a first flanging 104 extending vertically is disposed at a periphery of the smoke inlet 102, and a second flange extending vertically is disposed at a periphery of the smoke passing hole 61. The first flanging 104 and the second flange are sleeved to fit with each other, and thus the smoke inlet 102 and the smoke passing hole 61 can be fitted more closely to prevent a leakage of the flue gas.

In some embodiments, a diversion slope 63 is disposed at a top wall of the cavity body. The diversion slope 63 is disposed to extend obliquely upward from a side of the cavity body away from the smoke passing hole 61 to a side of the cavity body close to the smoke passing hole 61. In this way, the flow resistance of the flue gas in the cavity body can be reduced, and thus the flue gas can quickly flow along the diversion slope 63 to the smoke passing hole 61 and then flow into the housing 10.

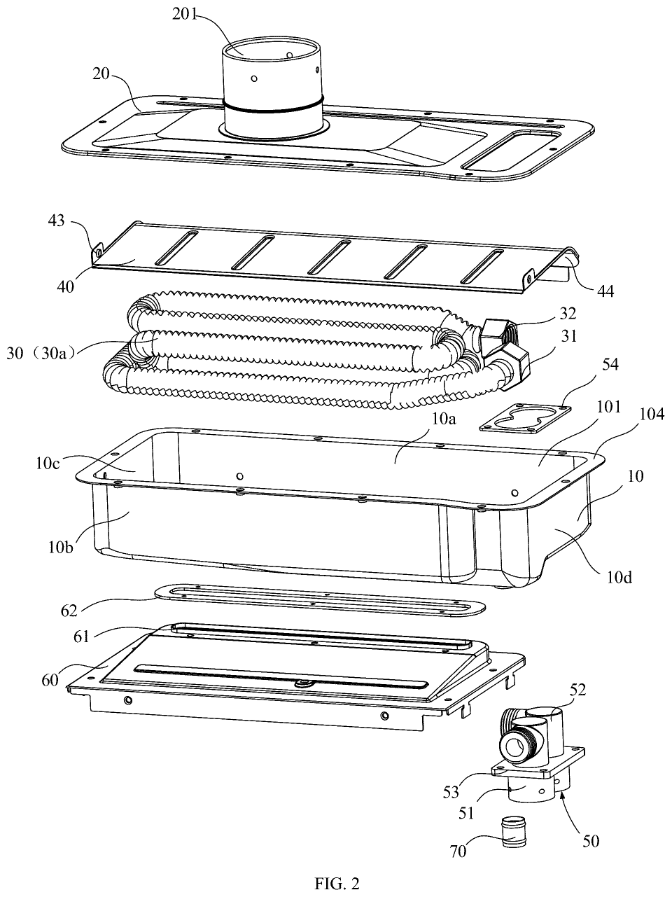

In combination with the above embodiments, as shown in FIG. 2 and FIG. 3, a portion of the bottom wall 11 of the housing 10 where the boss 12 is disposed is inclined. In some embodiments, a portion of a top wall of the connection flange 60 corresponding to the boss 12 is also inclined. Inclination directions of the above two portions are consistent. In this way, the top wall of the connection flange 60 matches the bottom wall 11 of the housing 10 in shape, to facilitate an installation of the connection flange 60 and the housing 10, and also facilitate an inner wall surface of an inclined portion of the connection flange 60 to form a diversion slope 63.

In practical applications, the connection flange 60 may be made of sheet metal. The cavity body having a diversion slope 63 may be formed on the connection flange 60 by a press molding process, and thus a forming process is simple and a manufacture is convenient.

As shown in FIG. 2, in an embodiment, the top wall of the connection flange 60 is provided with a first positioning portion. The bottom wall 11 of the housing 10 is provided with a second positioning portion. The first positioning portion and the second positioning portion may cooperate with each other for positioning. In this way, the connection flange 60 and the bottom wall 11 of the housing 10 can be easily positioned and assembled to improve an assembly efficiency. In some embodiments, a concave cavity (also known as the first positioning portion) is disposed at an outer side of the bottom wall 11 of the housing 10, and correspondingly, a convex portion (also known as the second positioning portion) protruding toward the concave cavity is disposed at the top wall of the connection flange 60. The convex portion is inserted into the concave cavity during assembly to achieve a positioning and fitting between the connection flange 60 and the housing 10. In some embodiments, positions of the concave cavity and the convex portion may be interchanged. In some embodiments, the first positioning portion and the second positioning portion may also adopt other positioning structures to achieve the positioning and fitting.

Combined with the above embodiments, the bottom wall 11 of the housing 10 may be provided with the convex portion by the press molding process, and accordingly, the concave cavity may be formed at the outer side of the bottom wall 11 of the housing 10 corresponding to the convex portion. The concave cavity may be used as a first positioning portion, and thus a forming process is simple and a manufacture is convenient.

In an embodiment, the open end of the housing 10 is folded outward to form a first flanging 104. Fixing holes for second fasteners to pass through are correspondingly disposed at the first flanging 104 and the smoke hood 20.

In some embodiments, the smoke hood 20 may include a hood body and a chimney disposed at a top of the hood body. The hood body has a smoke collecting chamber having an opening at bottom. Two ends of the chimney are disposed in a through manner. A top of the chimney is open to form a smoke outlet 201. The flue gas after being subject to the heat exchange flows upward to the smoke collecting chamber, in which the flue gas is collected, and then passes through the chimney to be discharged from the smoke outlet 201. In some embodiments, the smoke hood 20 can be connected and fixed to the open end of the housing 10 by fasteners (such as bolts), and thus a structure for assembling is simple. In other embodiments, an assembly portion is disposed at an outer edge of the smoke hood 20. A transversely bent first flanging 104 is disposed at the open end of the housing 10. Fixing holes for fasteners to pass through are correspondingly disposed at the assembly portion and the first flanging 104. The assembly portion abuts against the first flanging 104 during assembly, and then the second fastener is passed through the fixing hole to lock and fix the smoke hood 20 and the housing 10. Thus the assembly is simple and convenient. In some embodiments, a third seal member is disposed between the smoke hood 20 and the first flanging 104 to ensure a reliability of sealing and prevent a leakage of the flue gas. The third seal member includes but is not limited to a sealant, a sealing cotton and so on.

The disclosure also proposes a gas device, which includes a condensing heat exchanger 100. A specific structure of the condensing heat exchanger 100 refers to the above embodiments. Since the gas device adopts all the technical solutions of all the above embodiments, the gas device has at least all the advantageous effects brought by the technical solutions of the above embodiments, which will not be repeated here.

The above are only some embodiments of the disclosure, and does not limit a protection scope sought by the disclosure. All equivalent structural changes made by using the contents of the specification and accompanying drawings of the disclosure, or directly/indirectly used in other related technical fields are included in the protection scope sought by the disclosure.

What is claimed is:

1. A condensing heat exchanger comprising:
a housing, formed by integral stretching of a metal material and having an accommodation cavity with an opening at an end of the housing;
a smoke hood, covering an open end of the housing to form a sealed cavity, and provided with a smoke outlet in communication with the sealed cavity, the housing being provided with a smoke inlet in communication with the sealed cavity; and
a heat exchange member, disposed in the sealed cavity.

2. The condensing heat exchanger according to claim 1, wherein a projection of the heat exchange member on the bottom wall of the housing is offset from the smoke inlet.

3. The condensing heat exchanger according to claim 1, further comprising:
a baffle plate disposed in the accommodation cavity;
wherein:
a diversion flue duct is formed between the baffle plate and a bottom wall of the housing, and the heat exchange member is disposed in the diversion flue duct;
the smoke inlet is disposed at the bottom wall of the housing;
a smoke passing port communicating with the diversion flue duct and the smoke outlet is disposed at the baffle plate; and
the smoke inlet and the smoke passing port are disposed far away from each other.

4. The condensing heat exchanger according to claim 3, wherein:
the housing has a first side and a second side disposed opposite to each other, a direction in which the first side and the second side are disposed opposite to each other intersecting a vertical direction; and
an end of the baffle plate is connected to the first side, and another end of the baffle plate is spaced apart from the second side to form the smoke passing port, the smoke inlet being disposed close to the first side.

5. The condensing heat exchanger according to claim 4, wherein the baffle plate has a diversion surface facing the smoke inlet, the diversion surface being an arc-shaped surface arched toward a direction away from the smoke inlet.

6. The condensing heat exchanger according to claim 4, wherein:
the baffle plate includes a first plate section and a second plate section arranged along the direction in which the first side and the second side are disposed;
the first plate section is connected to the first side and faces the smoke inlet obliquely;
the second plate section extends from a side of the first plate section close to the second side and is tilted downward;
the bottom wall of the housing is provided with a boss facing the second plate section and having a same inclination direction as the second plate section; and
the diversion flue duct is formed between the second plate section and the boss.

7. The condensing heat exchanger according to claim 6, wherein the second plate section and the boss are inclined downward relative to a horizontal plane at an angle not less than 5 degrees and not more than 10 degrees.

8. The condensing heat exchanger according to claim 6, wherein:
a first rib is disposed at a top surface of the boss;
a second rib is disposed at a bottom surface of the second plate section; and
the first rib and the second rib abut against two opposite sides, respectively, of the heat exchange member.

9. The condensing heat exchanger according to claim 4, wherein the heat exchange member includes a corrugated pipe disposed in a curved shape.

10. The condensing heat exchanger according to claim 9, wherein:
the direction in which the first side and the second side are disposed is a first direction;
the housing further has a third side and a fourth side disposed opposite to each other along a second direction;
the corrugated pipe is bent back and forth between the third side and the fourth side; and
the first direction, the second direction, and the vertical direction intersect one another.

11. The condensing heat exchanger according to claim 4, wherein a water collection groove is disposed at a position of the bottom wall of the housing close to the second side, a drain port being disposed at a bottom wall of the water collection groove.

12. The condensing heat exchanger according to claim 1, further comprising:
a water inlet connector in communication with a water inlet end of the heat exchange member; and
a water outlet connector in communication with a water outlet end of the heat exchange member;
wherein the housing has slotted holes for ends of the water inlet connector and the water outlet connector to respectively penetrate for connecting and fixing.

13. The condensing heat exchanger according to claim 12, further comprising:
a mounting member on which the water outlet connector and the water inlet connector are mounted, the mounting member being connected to the housing;
wherein the water inlet end and the water outlet end of the heat exchange member are disposed at a same side of the heat exchange member.

14. The condensing heat exchanger according to claim 13, wherein a seal member is disposed between connection surfaces of the mounting member and the housing.

15. The condensing heat exchanger according to claim 1, further comprising:
a baffle plate disposed in the accommodation cavity;
wherein:
a connection member protrudes from a periphery of the baffle plate in a vertical direction;
first through holes are opened on the connection member;
second through holes are opened on a side wall of the housing, each of the second through holes corresponds to one of the first through holes; and
the baffle plate is fixed to the housing by fasteners passing through the second through holes and the first through holes in sequence.

16. The condensing heat exchanger according to claim 1, further comprising:
a connection flange disposed at a bottom of the housing;
wherein:
the connection flange is provided with a cavity body having an opening facing downwards; and
a top wall of the connection flange is provided with a smoke passing hole communicating the cavity body to the smoke inlet.

17. The condensing heat exchanger according to claim 16, wherein a seal member is disposed between connection surfaces of the smoke passing hole and the smoke inlet.

18. The condensing heat exchanger according to claim 16, wherein:
a diversion slope is disposed at a top wall of the cavity body; and
the diversion slope is disposed to extend obliquely upward from a side of the cavity body away from the smoke passing hole to a side of the cavity body close to the smoke passing hole.

19. The condensing heat exchanger according to claim 1, wherein:
the open end of the housing is folded outward to form a flanging; and
fixing holes for fasteners to pass through are correspondingly disposed at the flanging and the smoke hood.

20. A gas device comprising:
a condensing water heater including:
a housing, formed by integral stretching of a metal material and having an accommodation cavity with an opening at an end of the housing;
a smoke hood, covered on an open end of the housing to form a sealed cavity, and provided with a smoke outlet in communication with the sealed cavity, the housing being provided with a smoke inlet in communication with the sealed cavity; and
a heat exchange member, disposed in the sealed cavity.
